(19) United States
(12) Patent Application Publication
(10) Pub. No.: US 2012/0255820 A1
(43) Pub. Date: Oct. 11, 2012

(54) Segmented brake rotor with externally vented carrier

(76) Inventors: Geoffrey K. McCord, Toronto (CA); Ralph Hansen, Toronto (CA)

(21) Appl. No.: 13/407,682

(22) Filed: Feb. 28, 2012

Related U.S. Application Data
(60) Provisional application No. 61/629,751, filed on Nov. 25, 2011.
(60) Provisional application No. 61/464,280, filed on Mar. 1, 2011.

(51) Int. Cl. F16D 65/12; F16D 65/847

(52) U.S. Cl. 188/218 XL

(57) ABSTRACT

An externally vented brake rotor (EVR) core design, such as exemplified by U.S. Pat. No. 6,536,564, is being used to improve the function and effectiveness of a segmented brake rotor (SBR) through more efficient management of the thermal forces created in the segmented rotor. Specifically, segmented friction plates are attached to the EVR core to form friction surfaces. Air flow through the vents contacts the back side of the friction plates. At least one segmented friction plate may be provided with a tab or protrusion that engages a corresponding receiving recess in the carrier surface of the EVR core, thereby relieving lateral stress forces.

### CROSS-REFERENCE TO RELATED APPLICATIONS

This application claims the benefit of U.S. Provisional Patent Application No. 61/629,751, filed on Nov. 25, 2011, as well as U.S. Provisional Patent Application No. 61/464,280, filed on Mar. 1, 2011, both in the names of Geoffery K. McCord et al., and entitled “Segmented Brake Rotor with Externally Vented Carrier”. The entire contents of these earlier filed and commonly owned patent applications is herein expressly incorporated by reference.

### STATEMENT REGARDING U.S. FEDERALLY SPONSORED RESEARCH

None.

### BACKGROUND OF THE INVENTION

1. Field of the Invention

The present invention relates to braking systems for vehicles, including aircraft, and more particularly pertains to the brake rotors and segmented brake rotors in a disc braking system.

2. Discussion of Related Art

Increasing fuel prices, fuel economy and emission standards provide incentive to reduce the mass of vehicles by substituting light weight components in place of heavy steel or cast iron components. A large opportunity for such mass reduction exists in the vehicles' braking system.

A disc-and-caliper braking system is increasingly common on motor vehicles, and in particular, becoming more common on military, commercial and vocational vehicles. In this system, braking is effected by high pressure hydraulic fluid forcing one or more pistons in a caliper to press a pair of brake pads against the friction surface of a brake rotor. The brake rotor is connected to, and rotates at the same speed as the wheel of the vehicle. The brake rotor traditionally is made from a ferrous-based material such as cast iron or steel. These materials have worked well for many years, but suffer from relatively high weight.

In recent times, brake designers have experimented with brake rotors based on aluminum and its alloys. Aluminum is much lighter than iron or steel, but cannot operate at as high a temperature as iron steel, a significant drawback in a braking system where operating temperatures can exceed 600 C. Aluminum also has a much higher coefficient of thermal expansion (CTE) than does iron or steel. An aluminum brake rotor that is constrained as it heats up under braking action is at risk of warping or buckling. Aluminum also has a much higher thermal conductivity than does iron or steel. As such, if the heat of braking is not dissipated into the surrounding air, it will more quickly travel into the surrounding structure to which it is mounted, which could have an adverse effect on other component material and lubricants.

Accordingly, many brake rotor designs rely on vents to help dissipate heat into the surrounding air. Incorporating vents into the brake rotor design adds complexity and therefore cost. To present a uniform friction surface, the vent designs typically are internal to the brake rotor. Brake rotors typically are made by a casting process. Unless the rotor is cast in two half-disc units and later assembled, the internal vents cause difficulty in casting, what with metal having to be cast around sand or similar cores, and the cores subsequently being removed to create the vents.

U.S. Pat. No. 6,536,564 addresses the problem of casting in the vents in a vented brake rotor design, more specifically an aluminum composite or Metal Matrix Composite(MMC) brake rotor design. Specifically, and in one particular embodiment, a vented disc brake rotor features first and second braking surfaces that jointly define inner and outer circumferential surfaces and a central region. A hub surface is disposed in the central region and contains a main aperture adapted for mounting the rotor onto a vehicle. A plurality of curved directing walls are disposed between the first and second braking surfaces to define a plurality of flow channels. Each flow channel extends from the inner circumferential surface to the outer circumferential surface. A curved separating wall is disposed in each flow channel and extends from a point between the inner and outer circumferential surfaces to the outer circumferential surface. The separating wall can divide the flow channel into two subchannels. Also, the separating wall has a width that increases from its first end to its second end located at the outer circumferential surface. As a result, each flow channel has a total cross-sectional area that remains substantially constant from the inner circumferential surface to the outer circumferential surface. Lastly, a plurality of directing fins is disposed on the inner circumferential surface. Each directing fin defines a directing surface and is adapted to direct air into a flow channel positioned adjacent the directing fin. Each flow channel may be opened to one of the braking surfaces, giving a gapped or intermittent configuration to the braking surface(s). This configuration may facilitate manufacturing by allowing the first and second braking surfaces to be integrally formed by a singular brake member by a suitable process, such as die-casting or squeeze-casting.

Another problem with a light metal such as aluminum is that it is softer than iron or steel, and thus wears out faster in frictional contact with a brake pad. Accordingly, some brake designers have modified the frictional surface of an aluminum brake rotor to address the wear problem and to maintain or perhaps even enhance the frictional characteristics of the surface. A popular approach to this modification is to add or incorporate wear plates to the brake rotor frictional surface. In its simplest form, the wear plates take the form of an annular ring attached to each of the two frictional surfaces in a typical brake rotor. The attachment may be by means of common fasteners such as bolts or rivets. In another embodiment, the frictional surfaces of the brake rotor are machined somewhat to accommodate the thickness of the annular rings without changing the overall profile or thickness of the original brake rotor.

One common issue with this approach is that there is often a large difference in the CTE between the wear plates and the aluminum substrate, chassis or “carrier”. As the system heats up, the wear plates and carrier attempt to expand at different rates. Since they are constrained, at least to some degree, there is the potential to warping or buckling of the carrier, or fracture of the wear plates.

One modification that at least partially addresses this problem is to break up the annular wear plate ring into a plurality of wear or friction plate segments. In addition to the known fasteners, wear or friction plate segments can be attached to the brake rotor carrier and held in position by machining recesses in the friction surfaces, and placing the wear or friction plate segments into the recesses. U.S. Pat. No. 6,935,470 is but one example among many of this approach.

Despite these developments, there are still problems with applying wear plates, segmented or annular, to the friction surfaces of a brake rotor carrier fashioned from a lightweight metal such as aluminum. In particular, a common deficiency exists in segmented rotors in the absorption and dissipation of the heat created on the braking friction surfaces. Heat management, even in internally vented rotor carriers, remains a significant performance issue as the rotor cannot dissipate the heat generated during the braking action quickly. The instant invention addresses and solves this problem.

### SUMMARY OF THE INVENTION

In accordance with the instant invention, the externally vented brake rotor (EVR) core design, such as exemplified by U.S. Pat. No. 6,536,564, is being used to improve the function and effectiveness of a segmented brake rotor (SBR) through more efficient management of the thermal forces created in the segmented rotor. In particular, an EVR is resized as required in the friction surface area to accept two or more segmented wear plates that are fastened to the resized rotor “carrier” platform. The friction wear plates can be any available suitable braking material such as cast iron, stainless steel, MMC alloys, titanium, carbon ceramic and so on, which are fastened to the rotor carrier using commonly known mounting fasteners such as rivets. The novel design of the EVR, when applied to the segmented rotor carrier platform, results in improved convection, radiation and conductive heat dissipation, and increased transfer of heat from the friction plates to the lightweight rotor carrier platform for dissipation.

### BRIEF DESCRIPTION OF THE FIGURES

FIG. 1 is a peripheral view of a prior art brake rotor.

FIG. 2 is a peripheral view of a brake rotor carrier according to a first embodiment of the present invention.

FIG. 3 is a radial sectional view of a rotor similar to the rotor illustrated in FIG. 2.

FIG. 4 is a magnified view of the brake rotor illustrated in FIG. 3.

FIG. 5 is peripheral view of a brake rotor carrier according to a second embodiment of the invention.

FIG. 6A is a side and top view of a single friction plate segment.

FIG. 6B is an isometric view of a friction plate segment featuring a pair of tabs or protrusions designed to engage corresponding recesses in a carrier surface.

FIG. 7 is an exploded isometric view of the major components of a vented brake rotor embodiment of the instant invention.

FIG. 8 is an isometric view of an assembled vented brake rotor embodiment of the instant invention.

### DETAILED DESCRIPTION OF THE INVENTION

The invention is an extension of U.S. Pat. No. 6,536,564 for an externally vented brake rotor (EVR). The EVR core design is being used to improve the function and effectiveness of a segmented brake rotor (SBR) through more efficient management of the thermal forces created in the segmented rotor. A common deficiency exists in segmented rotors in the absorption and dissipation of the heat created on the braking friction surfaces. The novel design on the EVR, when applied to the segmented rotor carrier platform, results in improved convection, radiation and conductive heat dissipation, greater surface area, increased volume and velocity of air flow through and around the rotor friction area and increased transfer of heat from the friction plates to the lightweight rotor carrier platform for dissipation.

The invention contemplates an alloy, alloy composite or ultra light composite(common aluminum compounds, MMC, high strength aluminum polymer, carbon fiber, etc.) based EVR, resized as required in the friction surface area to accept two or more segmented wear plates that are fastened to the resized rotor “carrier” platform. The friction wear plates can be any available suitable braking material such as cast iron, stainless steel, MMC alloys, titanium, carbon ceramic and so on, which are fastened to the rotor carrier using commonly known mounting fasteners such as rivets. Different materials can be used as the friction plates at the same time, either on one or the other friction surface, or alternating on the same surface.

### The Internally Vented Brake Rotor (Not Part of the Instant Invention)

Before the concept of the “Externally Vented Brake Rotor” can be discussed, some terminology must first be discussed and explained in the context of the Internally Vented Rotor (IVR). The IVR is not part of the instant invention.

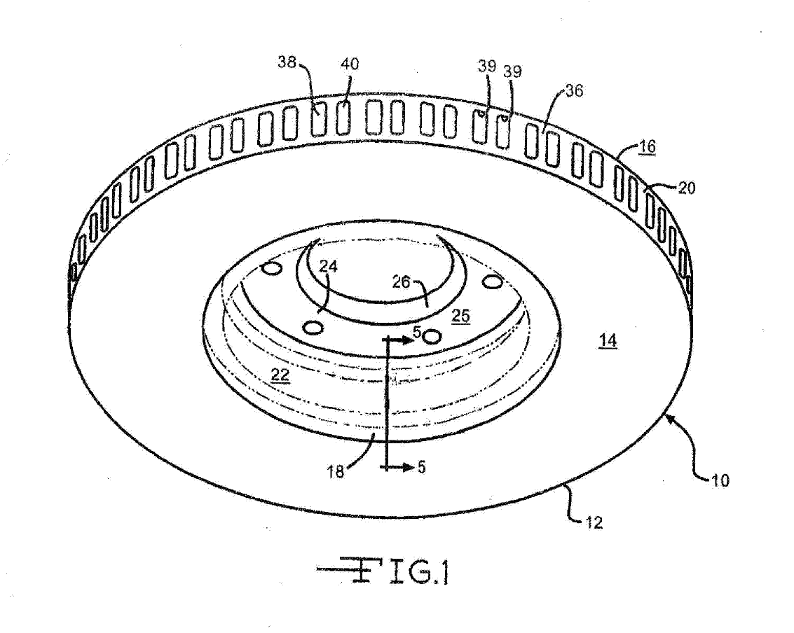

FIG. 1 illustrates an internally vented disc brake rotor 10. The rotor 10 comprises a brake member 12 having first 14 and second 16 braking surfaces. Also, the rotor 10 has an inner circumferential surface 18 and an outer circumferential surface 20. The braking surfaces 14, 16 are annular and therefore define a central region 22. A hat region 24 is disposed in the central region 22, and defines mounting surface 25 and a hub pilot 26. In use, the rotor 10 is mounted to a shaft end, such as an axle, by passing the shaft end through the hub pilot 26 and securing the mounting surface 25 to a mounting portion of the shaft, such as conventional wheel studs.

### The Externally Vented Brake Rotor (a Part of the Instant Invention)

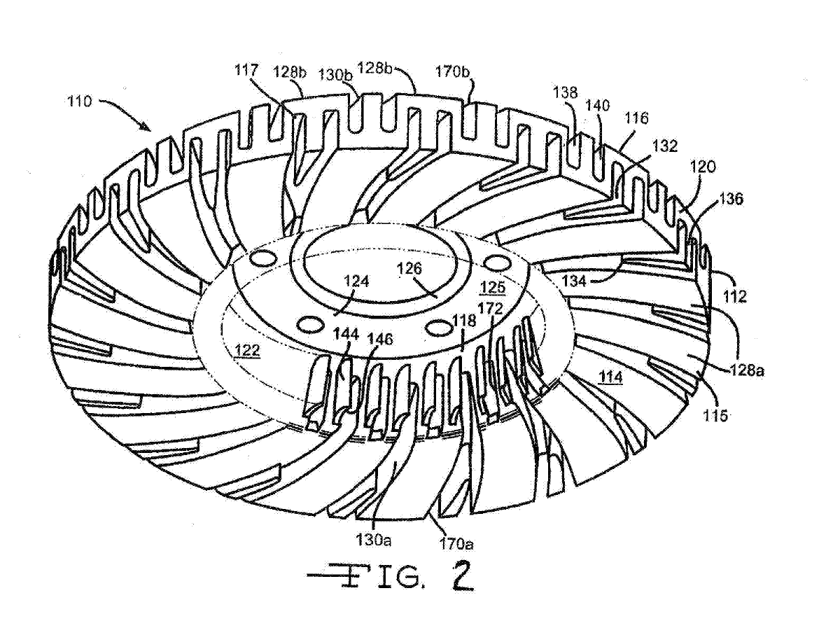

FIG. 2 illustrates a first embodiment of a brake rotor that can be used in connection with the instant invention.

In this embodiment, the rotor 110 includes a singular brake surface member 112 that defines the first 114 and second 116 braking surfaces. Also, a first plurality of directing walls 128a extends from an underside 115 of the first braking surface 114 toward the second braking surface 116, and a second plurality of directing walls 128b extends from an underside 117 of the second braking surface 116 toward the first braking surface 114.

Also preferable, the first braking surface 114 defines a first plurality of gaps 170a that provide access to at least one of a first set of flow channels 130a. Likewise, the second braking surface 116 defines a second set of gaps 170b providing access to at least one of a second set of flow channels 130b. Preferably, each flow channel of the first set of flow channels 130a is disposed between two flow channels of the second set of flow channels 130b. In this arrangement, the rotor 110 includes flow channels 130 oriented towards opposing braking surface 112, 114 in an alternating fashion.

Also, the gaps 170a providing access to the first set of flow channels 130a extend into the inner circumferential surface 118. Since the hat region 124 is disposed between the second set of flow channels 130b and the inner circumferential surface 118, an aperture 172 in the inner circumferential surface 118 provides fluid access to the second set of flow channels 130b.

A separating wall 132 is preferably disposed within each flow channel 130. Each separating wall 132 is a solid wall member having first 134 and second 136 ends. The first end 134 is preferably disposed at a point between the inner circumferential surface 118 and the outer circumferential surface 120. Particularly preferable, the first end 134 is disposed at a point nearer the outer 120 circumferential surface than the inner circumferential surface 118. The second end 136 preferably comprises a portion of the outer circumferential surface 120. Similar to the directing walls 128, the separating walls 132 can be straight or curvilinear in form. Preferably, the separating walls 132 are similar in form to the directing walls 128. Accordingly, the separating walls 132 preferably have a curved configuration. Each side of the separating wall 132 preferably conforms substantially to the curvilinear shape of the adjacent directing wall 128.

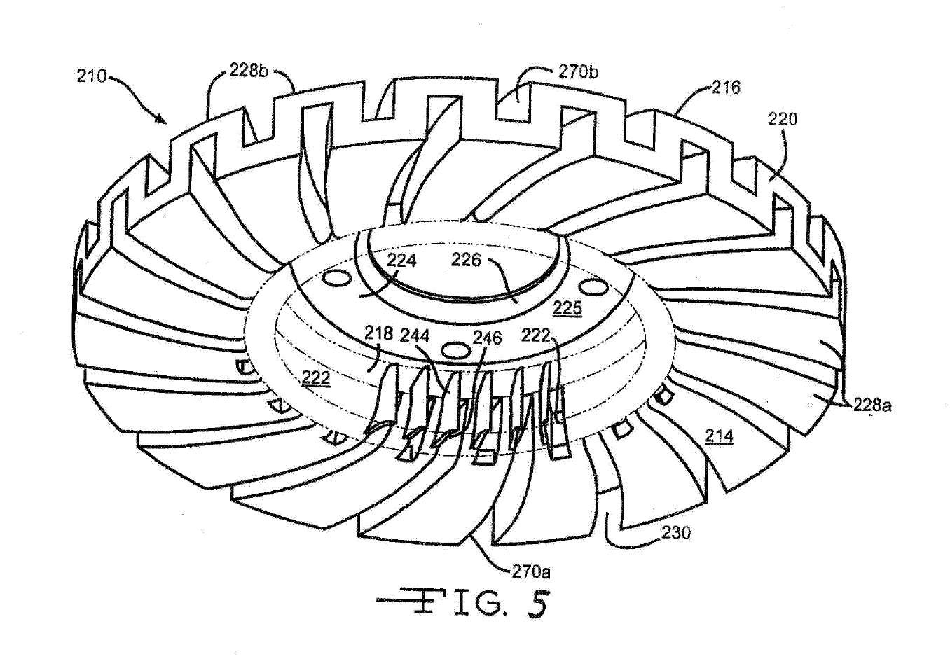

Similar to the directing walls 128, the separating walls 132 preferably extend from an underside of the first braking surface 114 to an underside of the second braking surface 116. As a result, each separating wall 132 can maintain a unitary channel design or divided the appropriate flow channel 130 into first 138 and second 140 subchannels. The channel or subchannels 138, 140 terminate in openings 139 on the outer circumferential surface 20. Thus, as best illustrated in FIG. 2, the flow channels 130 begin as a single passageway at the inner circumferential surface 118 and terminate at the outer circumferential surface 120 as either a single passageway 230 (best seen in FIG. 5) or two independent passageways FIG. 2 138, 140 as may be required by the application.

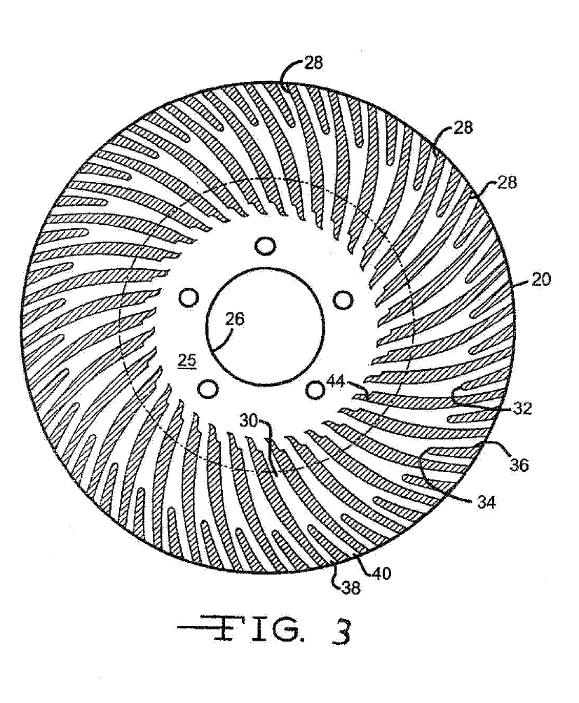

FIG. 3 is a longitudinal cross-section of a brake rotor design similar but not necessarily identical to that illustrated in FIG. 2. As best illustrated in FIG. 3, a plurality of directing walls 28 are disposed between the first 14 and second 16 braking surfaces. The directing walls 28 can be straight or curvilinear in form. As illustrated in FIG. 3, the directing walls 28 preferably extend from the inner circumferential surface 18 to the outer circumferential surface 20 along a curvilinear path. Also preferable, the directing walls 28 extend from an underside of the first braking surface 14 to an underside of the second braking surface 16.

As a result of this configuration, each adjacent pair of directing walls 28 define a flow channel 30 that extends from the inner circumferential surface 18 to the outer circumferential surface 20. The flow channel 30 is open at both ends, thereby allowing fluid communication between the central region 22 and outer 20 circumferential surfaces. Also, in the embodiment illustrated in FIG. 3, the flow channels 30 have a curved configuration due to the curvilinear shape of the directing walls 28.

Referring again to FIG. 2, the total cross-sectional area of each flow channel 130 preferably remains substantially constant over the length of the flow channel 130 from the inner circumferential surface 118 to the outer circumferential surface 120. That is, the cross-sectional area of the flow channel 130 at a point near the inner circumferential surface 118, i.e., a point on the flow channel 130 in which the flow channel comprises a single passageway, is preferably substantially identical to the sum of the cross-sectional areas of the first 138 and second 140 subchannels at a point near the outer circumferential surface 120

A plurality of directing fins 144 project into the central region 122. Preferably, the fins 144 are defined by the brake member 112. The fins can be, however, separately attached members. Each directing fin 144 is disposed adjacent a flow channel 130. Also, each directing fin 144 defines a directing surface 146 that directs air into the flow channel 130. Preferably, as best illustrated in FIG. 2, the directing surface 146 comprises a curved or angulated surface. This allows the directing fin 144 to alter the course of air encountering the directing surface 146 and direct it into the flow channel 130.

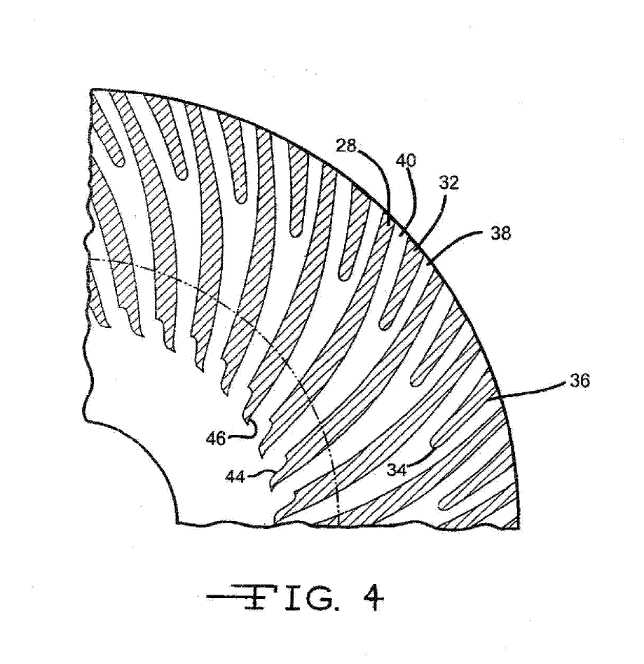

FIG. 3 shows a side view in cross section of similar directing fins. FIG. 4 is a higher magnification view of FIG. 3. Here, the directing fins are identified as 44, the directing wall is 46, and the flow channel is 30.

FIG. 5 illustrates a brake rotor according to a second embodiment that can be used in connection with the present invention. This embodiment is similar to the first embodiment except as detailed below. Accordingly, like references numbers refer to similar features and/or components illustrated in FIG. 2.

In this embodiment, flow channels 230 have a constant width along their length from the inner circumferential surface 218 to the outer circumferential surface 220. The desired substantially constant cross-sectional area is accomplished in this embodiment by elimination of the separating wall 132 in FIG. 2. Accordingly, flow channels 230 are unitary, lacking the first and second subchannels of the previous embodiments.

The brake rotor carriers of the present invention can be fabricated by any suitable manufacturing process. However, the brake rotors of the first and second embodiments of the present invention are advantageously fabricated using various suitable casting techniques. Due to the unitary design of the brake member, the rotors of these embodiments can be made using suitable dies configured to produce the desired pattern of flow channels in the braking surfaces. Examples of suitable fabrication techniques include die-casting, sand-casting, and squeeze-casting using methods and techniques known to those skilled in the art.

### Segmented Friction Plates

The invention will now be discussed in terms of how the segmented friction plates function in combination with the externally vented brake rotor carrier design.

In essence, the surfaces of the externally vented rotor that formerly were braking surfaces are now carrier surfaces for the plurality of segmented friction plates. More specifically, the carrier surfaces are termed “the first and second friction plate carrier surfaces”. When the plurality of the segmented friction plates are properly positioned and fastened to the first and second friction plate carrier surfaces, they define the first and second braking surfaces.

In one aspect of the instant invention, the replaceable friction plates reside between a separating shoulder or locating ridge to relieve lateral stress forces. Alternatively, where a separating shoulder is not available, a positioning or locating “tab”, or other form of protrusion on the underside of the plate can be employed to exactly locate the plate and relieve the lateral stress forces. Specifically, such tab or protrusion is arranged to engage a corresponding recess located on the carrier surface. Alternatively, the tab or protrusion may be located on the carrier surface, with the receiving recess located on the friction plate.

In another aspect of the invention, the friction plates attach directly (e.g., with known fasteners such as rivets) to the first and second friction plate carrier surfaces. Either way, the friction plates are positioned directly over the cooling channels. Accordingly, the cooling channels will be strategically located to maximize the cooling to the underside of the friction plates. In addition the friction plates optionally may incorporate cross-drilled though-holes either directly over the cooling channel or elsewhere on the friction wear plates to provide further cooling efficiency.

Many methods of attachment of the friction plates to the brake rotor carriers are available to one skilled in the art, including rivets, bolts, retainment rings, side plate flanges, gear rotor edges, dovetail flanges, or generally some interlocking device.

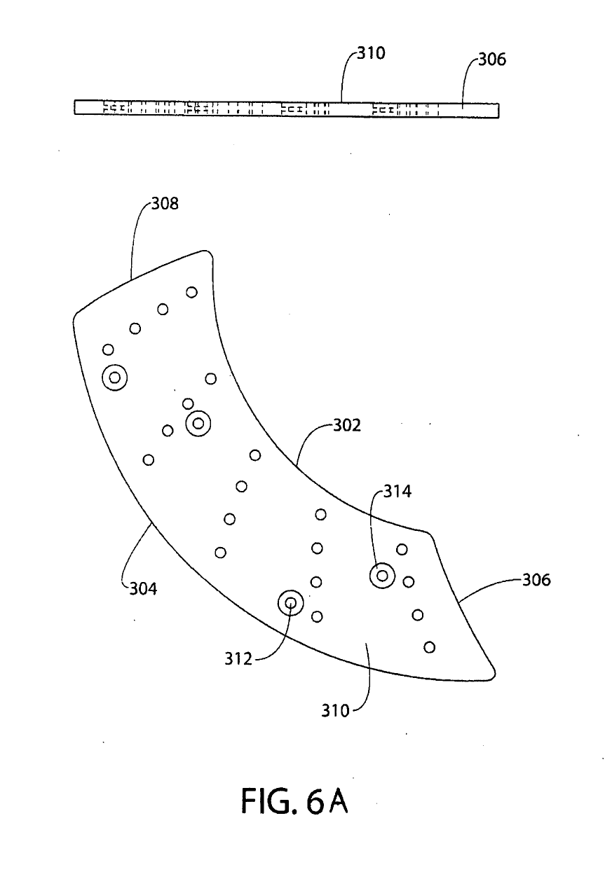

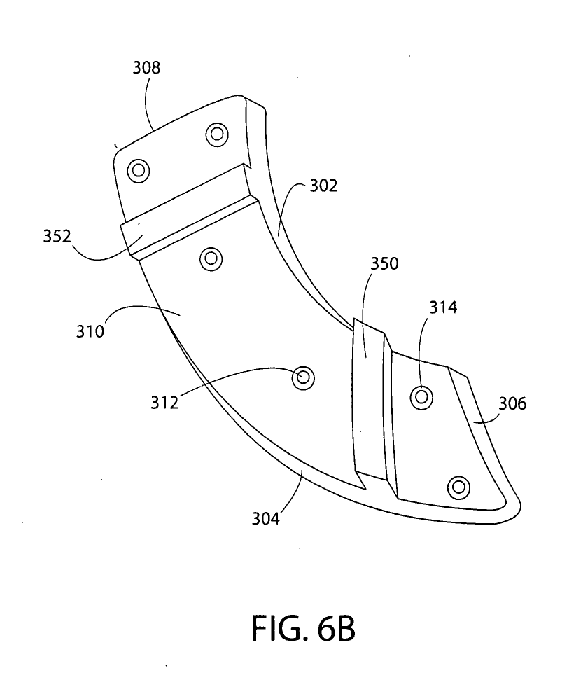

Referring now to FIG. 6A, what is shown is a single friction plate segment from side and top views. Shown are inner circumferential edge 302, outer circumferential edge 304, leading edge 306 and trailing edge 308. Surface 310 is a braking surface that contacts the brake pad during braking Through-holes 312 are for mounting the friction plate segment to the rest of the vented brake rotor, and specifically on the friction plate carrier. Zones 314 are countersunk regions so that the head of the fastener (bolt, rivet, etc.) will lie below the braking surface. Holes 316 are also through-holes, and specifically result form a cross-drilling operation. The purpose or function of these holes is to help cool the friction plate, specifically by creating additional surface area throughout the friction plate, and permitting cooling air to gain access to those surfaces throughout the friction plate, and exchange heat with those surfaces.

FIG. 6B illustrates, in isometric form, the embodiment of a single friction plate segment containing positioning tabs or protrusions. The cross-drilled holes, if such are desired, are not shown here to simplify the drawing. This embodiment features a pair of tabs or positioning protrusions. Positioning protrusion 350 is near leading edge 306, and positioning protrusion 352 is near trailing edge 308.

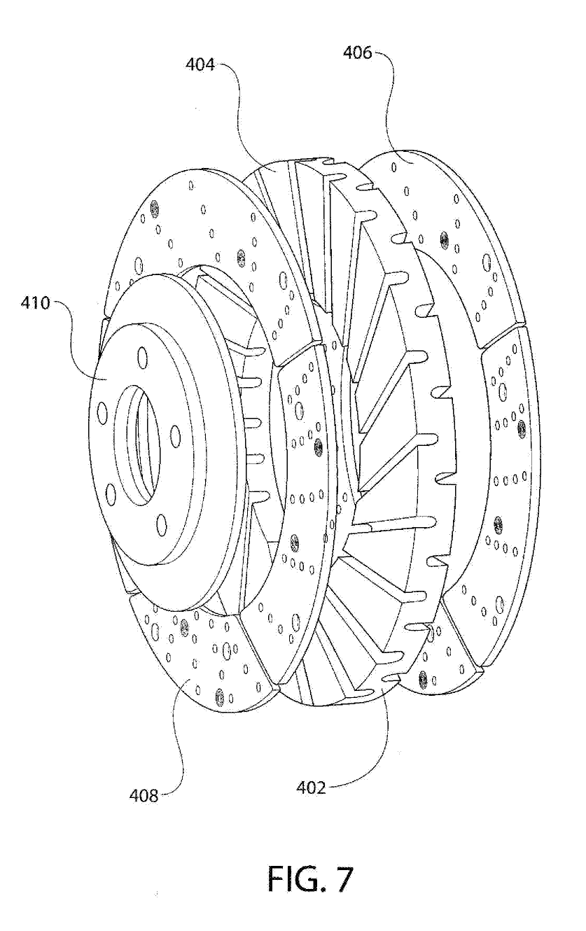

FIG. 7 is an exploded view in isometric view of the major components of the vented brake rotor of this embodiment of the instant invention, showing how the component parts are to be assembled with respect to one another. In particular, FIG. 7 shows how the plurality of segmented friction plates are arranged with respect to one another to form the first and second braking surfaces of the rotor. Brake rotor substrate body 402 has first (not shown) and second friction plate carriers 404 that support the friction plates 406, 408. Hat region 410 mounts within the central portion of the brake rotor substrate body.

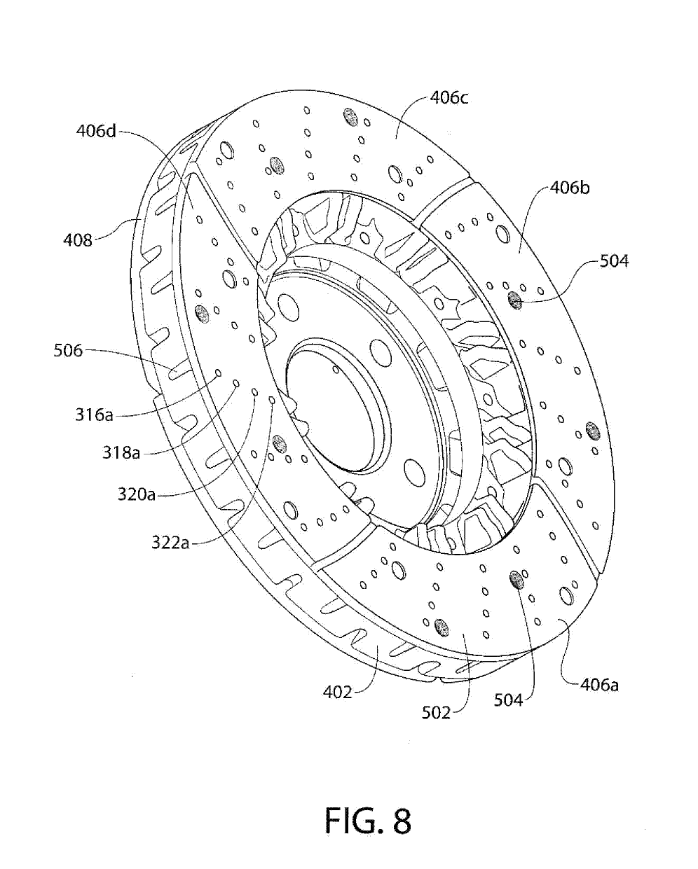

FIG. 8 is an isometric view of the assembled vented brake rotor. In particular, it shows a plurality of friction plates 406a, 406b, 406c, 406d attached to the first friction plate carrier surface of the brake rotor substrate body 402, thereby forming a first braking surface 502. The attachment is by means of fasteners 504. Note that through-holes 316a, 318a, 320a and 322a line up with channel 506, meaning that each of these through-holes is in fluid communication with channel 506. This means that air can flow into channel 506 at the inner circumferential surface, pass through holes 316a, 318a, 320a and 322a and exit at first braking surface 502, exchanging heat all along the way. During braking, each through hole also passes over a brake pad, so heat can also be directly extracted from the contact area between the brake pad and friction surface, thereby helping to cool the brake pads as well.

The preceding description of embodiments provide examples of the present invention. The embodiments discussed herein are merely exemplary in nature, and are not intended to limit the scope of the invention in any manner. Rather, the description of these embodiments and methods serves to enable a person of ordinary skill in the relevant art to make, use and perform the present invention.

### INDUSTRIAL APPLICABILITY

The vented brake rotor and segmented brake rotor carrier platform of the instant invention will provide the following benefits over known vented brake rotors; however, not all embodiments will necessarily feature all of these benefits.

### Improved Cooling

The EVR carrier or platform provides increased directional cooling air flow directly under the friction plates. This benefits rotor performance in two ways: by dissipating heat directly from the friction plates through the vent channels and reducing the heat storage in the rotor carrier platform. Further, heat stored in the light weight carrier can be dissipated quickly due to its greater mass and heat transfer design. Such storage and dissipation of heat is critical to broadening and maintaining the brake within its optimal performance range.

The “directional fins” embodied in the EVR patent, which operate as fan blades, increase the volume and velocity of cooling air through the cooling vents, thereby significantly increasing the cooling capacity and decreasing the associated heat build-up in the friction wear segments and platform or carrier.

The friction plates, cross-drilled (can be a variety of shapes and sizes, slots, ovals, circular etc) such that a series of cooling holes are placed, as required by application, through the friction plate area further increases the dissipation of heat from the friction plates. The size and shape flexibility is important to allow the part to be “tuned” to eliminate noise frequency that can develop.

The air cooling channels can be made, as provided in U.S. Pat. No. 6,536,564 with a “primary channel” and “secondary channels”, or with one uniform single channel. The channel design flexibility enables application specific design to address cooling, structural integrity, heat location management(i.e., if there is significantly greater heat in the outer edge region of the rotor segments)

Brake rotors are all cooled by convection, radiation and conductive heat dissipation. All three of these properties are improved by the invention's design and will result in:
Reduced brake fade;
Greater brake pad and rotor life;
Less thermal distortion from heat build up which results in warping and coning causing vibration and judder;
Extended component life from reduced heat transfer to wheel, axle hub and bearing components; and
Reduced metal fatigue and thermal cracking.

### One and Two-Piece Design

The flexibility of providing segmented rotor carriers in a one-piece design, where the mounting hat and friction segment carrier are integrated and a two-piece design, where the hat and friction segment carrier are two separate attached components provides complete flexibility of application and manufacture. The utilization of a two-piece design enables common carrier sizes to be mated to different mounting hat dimensions, providing greater fitment flexibility and reducing manufacturing costs by reducing the number of size dependent molds, inventory SKUs and all related ancillary costs such as freight, warehousing etc.

It is common that brake rotors, under high heat, warp, fade and generally lose braking effectiveness, sometimes referred to as judder or thermal judder. One of the primary cause of this judder is “Coning” or “Cupping” caused when the friction ring bends toward the hub region (inboard). The utilization of a two-piece design substantially eliminates this cupping, greatly improving the performance of the rotor, or segmented rotor.

### Reduced Manufacturing Cost and Manufacturing Flexibility

The externally vented design embodied by U.S. Pat. No. 6,536,564 provides important lower cost manufacturing when compared to traditional internal cooling channel designs used in segmented brake rotors. This results from the elimination of mold inserts (sand, clay or mechanical fingers) used to create common internal vent designs in alloy segmented rotors.

The externally vented design benefits from the flexibility to machine the rotor carrier to variable thickness requirements without concern for the limitations on structural integrity inherent in the internally vented rotor.

### Other Economic Benefits

The other large benefit is the logistical advantage to reduce shipping costs initially and create a secondary market of re-buildable rotor disc platforms with replaceable wear plates with fasteners in a box that costs even less to ship to the users/customers who include military, commercial, and vocational end-users.

### Light Weight

The alloy based SBR “carrier” as contemplated by this invention, embodies the structural integrity to absorb high stress while providing a significant weight reduction over common cast iron based segmented rotors.

The reduced weight of the rotor will reduce rotating mass and vehicle unsprung weight, allowing for overall vehicle weight reduction or redistribution of weight to critical component areas, such as batteries in hybrid vehicles.

An artisan of ordinary skill will appreciate that various modifications may be made to the invention herein described without departing from the scope or spirit of the invention as defined in the appended claims.

What is claimed is:

1. A vented disc brake rotor, comprising:
(a) a plurality of segmented friction plates;
(b) a surface member defining first and second friction plate carrier surfaces and a center region,
(c) inner and outer circumferential surfaces, and
(d) means for mounting said vented disc brake rotor to a vehicle, said plurality of segmented friction plates being releasably attached to said first and second friction plate carrier surfaces to define (i) first and second braking surfaces and (ii) a plurality of vents that permit air to enter at said inner circumferential edge, pass directly underneath said friction plates and exit at said outer circumferential edge.

2. The vented brake rotor of claim 1, further comprising at least one through-hole extending from said friction surface of at least one friction plate to a surface opposite said friction surface.

3. The vented brake rotor of claim 2, wherein said at least one through-hole is in fluid communication with at least one of said plurality of vents when said friction plate is installed on said surface member.

4. A vented disc brake rotor and disk brake carrier or platform, comprising:
(a) a plurality of segmented friction plates;
(b) a surface member defining first and second friction plate carrier surfaces and a center region,
(c) inner and outer circumferential surfaces,
(d) a plurality of directing walls; and
(e) means for mounting said vented disc brake rotor to a vehicle, said plurality of segmented friction plates being releasably attached to said first and second friction plate carrier surfaces to define first and second braking surfaces,; wherein pairs of the plurality of curved directing walls cooperate with an underside portion of the first friction plate carrier surface to define a first plurality of flow channels; wherein pairs of the plurality of directing walls cooperate with an underside portion of the second friction plate carrier surface to define a second plurality of flow channels; wherein each flow channel of the first and second pluralities of flow channels extends from the inner circumferential surface to the outer circumferential surface; wherein the first friction plate carrier surface defines a first plurality of gaps providing access to the first plurality of flow channels; and wherein the second friction plate carrier surface defines a second plurality of gaps providing access to the second plurality of flow channels.

5. The vented disc brake rotor of claim 4, wherein said directing walls are curved, and further comprising a plurality of curved separating walls, each of said plurality of curved separating walls being disposed between a pair of said plurality of curved directing walls.

6. The vented disc brake rotor of claim 5, further comprising a plurality of directing fins disposed on the inner circumferential surface, each of the plurality of directing fins disposed adjacent a flow channel and defining a directing surface adapted to direct air into the flow channel.

7. The vented disc brake rotor of claim 5, wherein the total cross-sectional area of each flow channel of the first and second pluralities of flow channels remains substantially constant from the inner circumferential surface to the outer circumferential surface or varies in cross sectional area as may be required by design and application.

8. The vented disc brake rotor of claim 5, wherein each flow channel of the first plurality of flow channels is disposed between two flow channels of the second plurality of flow channels.

9. The vented disc brake rotor of claim 5, wherein the first and second friction plate carrier surfaces are integrally formed by a singular brake member.

10. The vented disc brake rotor of claim 5, wherein said means comprises a hat region disposed in the central region.

11. The vented brake rotor of claim 1, wherein at least one of said segmented friction plate comprises a tab that engages a corresponding receiving recess in said carrier surface to which it is attached.

12. The vented brake rotor of claim 5, wherein at least one of said segmented friction plate comprises a tab that engages a corresponding receiving recess in said carrier surface to which it is attached.
